(19) United States
(12) Patent Application Publication
(10) Pub. No.: US 2011/0251751 A1
(43) Pub. Date: Oct. 13, 2011

(54) Motorized equipment tracking and monitoring apparatus, system and method

(76) Inventor: Lee Knight, Glendale, CA (US)

(21) Appl. No.: 13/065,031

(22) Filed: Mar. 11, 2011

Related U.S. Application Data
(60) Provisional application No. 61/340,051, filed on Mar. 11, 2010.
(60) Provisional application No. 61/401,948, filed on Aug. 20, 2010.

(51) Int. Cl. G06F 19/00

(52) U.S. Cl. 701/33

(57) ABSTRACT

A tracking system for monitoring motorized equipment, comprising a tracking device that is connectable to at least one equipment interface that is in communication with an equipment system and is adapted to sense a characteristic state associated with the equipment system, the tracking device including a power supply, memory means for storing at least a first equipment characteristic state, processing means having at least one program associated therewith for processing the first equipment characteristic state, the processing means being further adapted to generate a first equipment system history as a function of the first equipment characteristic state, and transmission means for receiving user command signals, and transmitting at least a first system signal representing at least a portion of the first equipment system history in response to a first user command signal.

### CROSS-REFERENCE TO RELATED APPLICATIONS

This application claims the benefit of U.S. Provisional Application Nos. 61/340,051, filed Mar. 11, 2010, and 61/401,948, filed Aug. 20, 2010.

### FIELD OF THE INVENTION

The present invention relates to systems for tracking and monitoring equipment. More particularly, the present invention relates to an apparatus, system and method for accurately tracking and monitoring operating information and data associated with motorized equipment.

### BACKGROUND OF THE INVENTION

Companies that depend on motorized equipment and/or vehicles (hereinafter referred to collectively as “motorized equipment or “equipment”) to support its business must carefully manage the use and maintenance of the equipment in order to realize the full potential of its Inves®ent(s). For example, a company or equipment owner wants to avoid running equipment outside of the manufacturer's specifications and to ensure proper and timely servicing. Without diligent care, costly repair and/or replacement costs can be incurred. This can be particularly true when a fleet of equipment is involved. Since the equipment typically is not in the hands of the people managing the company's bottom line, it can difficult to make sure this is achieved.

As is well known in the art, equipment owners typically rely on hour meters, which are installed on equipment, to schedule preventative maintenance, determine useful life and bill hours to a particular job or client. Analog meters are, however, inherently inaccurate. For example, one major meter manufacturer only warrantees meter accuracy to within ±5% out of the box. As the meter components become worn, the accuracy of the meter diminishes even more.

Factory digital meters experience similar discrepancies. However, the diminished accuracy is typically not as significant.

Advances in telematics (or telemetry) now allow equipment owners to install tracking devices on equipment to remotely track the location and movement of equipment, and operating data relating to the equipment, such as engine hours. The operating data can be transmitted over the air via cellular networks or satellite phone networks.

There is, however, at least one significant problem that is encountered with employing telemetry devices to monitor equipment. As is well known in the art, using a telemetry device to track engine hours often results in discrepancies between the hours recorded by and displayed on the originally installed meters (i.e., OEM meters) and the digital hour meters that are typically included in the tracking devices. This can, and in most instances will, result in confusion in the field.

It would thus be desirable to provide a telemetry system for tracking and monitoring motorized equipment that accurately records and reports operating data associated with the equipment and eliminates conflicting operating data; particularly, engine hours by and between OEM meters and the telemetry system meter.

### SUMMARY OF THE INVENTION

The present invention is directed to a telemetry apparatus and system for monitoring motorized equipment that accurately records and reports operating data associated with the equipment. In some embodiments, the telemetry apparatus and system is also adapted to track motorized equipment.

In one embodiment of the invention, the telemetry apparatus and system receives recorded operating data, e.g., engine hours, directly from a meter incorporated into the telemetry device. In a preferred embodiment, the engine hour data from the telemetry device is also transmitted and recorded on a new equipment meter, thereby eliminating the conflict in hours reported.

Another significant advantage of the invention is that it allows the engine (or motor) hours on an equipment meter to be modified by sending a message to the telemetry device over the air or with a programming cable. This is particularly beneficial when an equipment meter must be replaced due to non-function. Rather than installing a new meter and starting the hours again at zero (the hours recorded on the old meter must be also be added to the new meter to calculate the total hours), the invention allows the owner to update (or accurately reset) the telemetry meter and transmit the data to the equipment, whereby the original engine hours are recorded on the equipment meter.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 is a block diagram illustrating portions of one embodiment of an equipment tracking apparatus, in accordance with the invention;

FIG. 2A is a schematic illustration of an OEM engine meter and a conventional telemetry apparatus meter, showing the conventional connections thereof to an engine;

FIG. 2B is a schematic illustration of an OEM engine meter and an equipment tracking apparatus meter of the invention, showing a preferred connection by and between the OEM meter, the equipment tracking apparatus meter and an engine, in accordance with one embodiment of the invention;

FIG. 3 is a diagram illustrating a simplified and representative environment associated with equipment tracking apparatus and a host computer, in accordance with the invention;

FIG. 4 is a block diagram illustrating portions of an exemplary host computer, in accordance with the invention;

FIG. 5 is a top plan view of an XacTrac® digital hour meter;

FIG. 6 is an exploded, perspective view of one embodiment of a XacTrac® digital hour meter;

FIG. 7 is an assembled perspective view of the XacTrac® digital hour meter shown in FIG. 6;

FIG. 8 is an exploded, perspective view of another embodiment the XacTrac® digital hour meter shown in FIG. 6;

FIG. 9 is an assembled perspective view of the XacTrac® digital hour meter shown in FIG. 8; and

FIG. 10 is a front plan view of the XacTrac® digital hour meter shown in FIG. 9.

### DETAILED DESCRIPTION OF THE PREFERRED EMBODIMENT

Before describing the present invention in detail, it is to be understood that this invention is not limited to particularly exemplified apparatus, systems, structures or methods as such may, of course, vary. Thus, although a number of apparatus, systems and methods similar or equivalent to those described herein can be used in the practice of the present invention, the preferred apparatus, systems, structures and methods are described herein.

It is also to be understood that the terminology used herein is for the purpose of describing particular embodiments of the invention only and is not intended to be limiting.

Unless defined otherwise, all technical and scientific terms used herein have the same meaning as commonly understood by one having ordinary skill in the art to which the invention pertains.

Further, all publications, patents and patent applications cited herein, whether supra or infra, are hereby incorporated by reference in their entirety.

Finally, as used in this specification and the appended claims, the singular forms “a, “an” and “the” include plural referents unless the content clearly dictates otherwise. Thus, for example, reference to “a telemetry communication” includes two or more such communications and the like.

### DEFINITIONS

The terms “motorized equipment”, “equipment” and “vehicle”, as used herein, mean and include any mobile or stationary piece of equipment employing a motor or engine, including, but not limited to, automobiles, trucks, trailers, and construction equipment.

The terms “telemetry” and “telematic”, as used herein in connection with a device or system, mean and include an apparatus, system, or component thereof, that is designed and adapted to receive and/or transmit information and/or data via wired connections and/or over the air waves, e.g., BlueTooth connectivity.

The terms “engine” and “motor” are used interchangeable herein and mean and include any device or system that is adapted to convert any form of energy into mechanical force and/or motion.

The following disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

As will readily be appreciated by one having ordinary skill in the art, the present invention substantially reduces or eliminates the disadvantages and drawbacks associated with conventional tracking and monitoring systems for recording motorized equipment operating data; particularly, engine or motor hours.

In overview, the present disclosure is directed to equipment tracking devices, sometimes referred to as monitoring devices or telemetry devices, having the capability of sensing various conditions associated with a piece of equipment and/or a vehicle. These tracking devices can be installed in motorized equipment and can be electrically connected to various conventional sensors, relays and/or the like that can be provided in motorized equipment.

Much of the inventive functionality and many of the inventive principles when implemented, are best supported with or in software and/or integrated circuits (ICs), such as a digital signal processor and software therefore or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

As further discussed herein, various inventive principles and combinations thereof are advantageously employed to manage the use and maintenance of motorized equipment. The equipment tracking apparatus, system and/or method can be used by any company that manages equipment, including, for example, equipment owners, direct users and equipment lessors.

As stated, continuous tracking and recording of equipment use (e.g., speed, location, etc.) and status (e.g., oil pressure, engine hours, etc.) can, and in many instances will be, of vital importance. One or more embodiments described herein thus include an equipment tracking system, which can be mounted to the equipment, and/or a host computer for data logging and/or review of tracked data and optionally for control of the equipment.

Further, in accordance with exemplary embodiments, there is provided an equipment tracking system designed to address the need for continuous tracking and recording of equipment use (for example, speed, location, and/or the like) and/or status (oil pressure, engine hours, and/or similar). According to the invention, the equipment tracking system, which can be provided as unitary module, can be mounted to and optionally removed from the equipment.

In accordance with one embodiment of the invention, the equipment tracking system includes a tracking apparatus 103 that can be connected via interfaces to various elements in or on motorized equipment. The various elements can include one or more of the following, which are provided by way of example:
Sensors (for example, oil pressure, hydraulic fluid, air pressure, ignition switch, etc) conventionally provided in or on the equipment for which monitoring is desired. Sensor interfaces can include voltage sources, switches, and linear outputs.
Circuits conventionally provided in or on the equipment, where the circuits can be routed through relays in the tracking system. This can allow the equipment tracking system to switch the circuits, such as an alarm lamp or ignition disable, ON or OFF.
Satellite navigation system antenna (for example, GPS antenna) for locating the equipment and determining its velocity and heading.
Radio antenna for remote access to data stored by the equipment tracking system.

Referring now to FIG. 1, there is shown a block diagram illustrating portions of an exemplary equipment tracking apparatus 103, in accordance with various embodiments of the invention. As illustrated in FIG. 1, the equipment tracking apparatus 103 can include a satellite navigation system interface 117, a transceiver 107 and/or a computer port interface (represented by interface 121). The transceiver 107 alternatively can be provided as a transmitter and/or a receiver.

The equipment tracking apparatus 103 can also include one or more of the following: a sensor interface 109, a connection to a power supply 111, and/or relay switches 119. The equipment tracking apparatus 103, as depicted, also generally includes a processor 105, memory 123, and can include other functionality, which is not illustrated for the sake of simplicity.

The equipment tracking apparatus 103 can further include nonvolatile memory 113, which can be coupled to the processor 105, and/or a battery backed real time clock 115, which can similarly be coupled to the processor 105.

In a preferred embodiment, the equipment tracking apparatus 103 additionally includes an internal meter 116.

According to the invention, the processor 105 can comprise one or more microprocessors and/or one or more digital signal processors. Further, the memory 123, which is preferably coupled to the processor 105, can comprise a read-only memory (ROM), a random-access memory (RAM), a programmable ROM (PROM), and/or an electrically erasable read-only memory (EEPROM).

The memory 123 can also include multiple memory locations for storing, among other things, an operating system, data and variables for programs executed by the processor 105; computer programs for causing the processor 105 to operate in connection with various functions, such as location processing, status processing, event condition processing, recording processing, history transmission, relay switch processing, low power mode functionality, and/or other processing; and storage for other information used by the processor 105, such as configurations, lists, temporary variables and counters.

According to the invention, the computer programs can be stored, for example, in ROM or PROM and can direct the processor 105 in controlling the operation of the equipment tracking apparatus 103 and/or system.

Accordingly, one or more embodiments of the invention provides a telemetry/tracking apparatus (and associated system) suitable for use with motorized equipment, having sensors for sensing and indicating equipment status, the system comprising: a location interface for receiving a location signal indicating a current location when operably connected to a GPS antenna; a sensor interface for receiving sensor signals from sensors in or on the equipment, indicating a sensed status of the equipment when electrically or electronically connected to the sensors; and a processor cooperatively operable with the location interface and the sensor interface. The processor, e.g., a microprocessor, can communicate with the illustrated functional blocks within the vehicle tracking apparatus and can perform the programmed tasks.

The equipment tracking apparatus 103 conveniently can be configured to receive power from a power supply 111, such as a vehicle battery of the motorized equipment in which it is installed.

According to the invention, the battery backed real time clock 115 can be used to maintain time, even when the vehicle tracking device is powered OFF. The clock can also be “GPS Sync” enabled, which can synchronize the equipment tracking apparatus 103 to the time received in accordance with the satellite navigation system interface 117.

As illustrated in FIG. 1, the equipment tracking apparatus 103 is preferably provided with a transceiver 107. The transceiver 107 can be, for example, a digital cellular radio, provided for connection to a remote host computer, such as through the Internet and/or cellular and/or sat network; and/or a short range radio, such as a line of sight license free spread spectrum radio or the like.

The equipment tracking apparatus 103 can also include a computer port interface, for example a removable local connection, including a serial or parallel data connection, such as communications interface 121 and/or a USB interface, which can be a low cost alternative for communicating with the equipment tracking apparatus 103. The illustrated interface 121, for example, allows an interface cable to be connected between the equipment tracking apparatus 103 and the host computer.

Accordingly, one or more embodiments provide a computer port interface for transmitting communications when operably connected to a computer communication network; wherein the processor is further configured to facilitate transmitting, over the computer port interface, communications including the equipment data and/or history.

The equipment tracking apparatus 103 further preferably includes a sensor interface 109, to interface with one or more sensors in or on the equipment. The sensors can be of various types, such as those described above.

In some embodiments, the equipment tracking apparatus 103 tracks equipment functions, such as engine hours via the internal meter 116.

In some embodiments of the invention, the equipment tracking apparatus 103 utilizes independent timers to track equipment and/or vehicle functions. These timers can use sensor states provided from the sensor interface 109 as inputs, and can have an accumulator (for example, a 32 bit accumulator) to count time, such as seconds when an input function of the sensor state(s) evaluates to true. The input function can include one of various states (binary, ternary, or multi-state) for the sensors.

Accordingly, one or more embodiments provide at least one internal meter and/or timer, wherein the pre-defined event condition is timed in connection with the at least one internal meter and/or timer, and the time and associated event condition are recorded in the equipment history.

According to the invention, timer accumulators can be configured to reset to zero, e.g., when their input function=false, or maintain the count, e.g., the function=true again. Thus, in some embodiments, a specific timer, e.g., Timer 1, can be defaulted to be used as a “Run Hour Meter” that can accumulate when Sensor 1 is active.

The specific timer, e.g., Timer 1, can be saved to the non-volatile memory 113, for example, provided in the battery backed real time clock 115 or FLASH memory, so it can be preserved when power is disconnected.

In some embodiments of the invention, the equipment tracking apparatus 103 can record events when specific conditions are detected as being met. An event condition representing a defined event can be stored, for example, in non-volatile memory, where the event condition includes one or more of the following information, which is provided by way of example: (i) event type, (ii) timer or Sensor # relevant to the event type, (iii) date and/or time, (iv) current state of a designated sensor or all sensors (if desired), (v) timer configuration (if applicable), (vi) timer value (if applicable), (vii) GPS position data, (viii) engine hour meter value (e.g., Timer 1 value), and/or (ix) accumulated distance.

An event can also be prioritized, which may indicate, for example, the urgency or order of handling to be associated with an event.

According to the invention, the specific conditions that are met to cause a predefined event condition can include one or more of the following: a selected event type, a combination or series of selected event types, a sensor state, a combination of sensor states, a timer value, a particular GPS position data, a threshold or specified engine hour meter value, and/or a threshold or specified accumulated distance, alone or in combination; alternatively in combination with date and/or time.

Accordingly, one or more embodiments provide that when a new event occurs or when a predefined event condition occurs, a message can be transmitted in accordance with the transceiver 107 to the host computer indicating that the new event occurred, and/or including the event condition information. The transmission of the new event message can be enabled/disabled, for example, by event priority. The message period (how often it is transmitted) associated with the new event can also be specified as well as a timeout value.

Accordingly, one or more embodiments provide that the new event message can be repeatedly transmitted until the host computer responds or until the timeout value is reached. Alternatively, the host computer can periodically retrieve stored information regarding the events from the equipment tracking apparatus 103 in accordance with the transceiver 107 and/or the computer port interface.

The equipment tracking apparatus 103 is also preferably adapted to receive new and/or updated information and data, such as modified engine hours and satellite navigation system data (for example, GPS data) periodically, in accordance with the satellite navigation system interface 117 (also referred to herein as a location interface). In some embodiments, the data is received as records.

According to the invention, the equipment tracking apparatus 103 can divide up the records into package types. Thus, in some embodiments, the package types that are utilized by the equipment tracking apparatus 103 are selected based on the communication bandwidth and memory available: minimum record, normal record, and extended record.

According to the invention, a package type denominated as a “minimum record” can contain fix status and coordinate data. A package type denominated as a “normal record” can include the information in the minimum record plus the Timer 1 (engine hour meter value) accumulator value and the distance traveled accumulator. A package type denominated as “extended record” can include the information in the normal record plus additional information provided by the satellite navigation system, e.g., the time and/or date of fix, a velocity, an altitude above sea level, and/or an estimated position error.

The records can be made available from a conventional GPS, for example, in real time via a command in accordance with definitions provided by the GPS manufacturer. Moreover, the records received in accordance with the satellite navigation system interface 117 can be saved to memory, such as the nonvolatile memory 113. The period (how often the record is saved), package types, package lengths, and/or associated memory can also preferably be configured via a transmitted command.

In some embodiments of the invention, the processor 105 can provide status processing, whereby the processor 105 receives the sensed status, for example, from the sensor interface 109. The sensed status from the sensor interface 109 can be further processed, if desired, in accordance with analog-to-digital processing.

In some embodiments, the processor 105 is further adapted to provide recording processing, whereby various information can be recorded, for example, in nonvolatile memory or other local memory. Information that can be recorded includes, for example, data received from the satellite navigation system interface 117 (which can be transformed into desired record formats, such as the package types discussed above, prior to recording), event conditions, sensor states, and the like.

In a preferred embodiment, the processor 105 is additionally adapted to receive and record data from external hour meters associated with the equipment engine or motor. As will be appreciated by one having ordinary skill in the art, the external hour meter can comprise an OEM hour meter or a user installed (or aftermarket) hour meter.

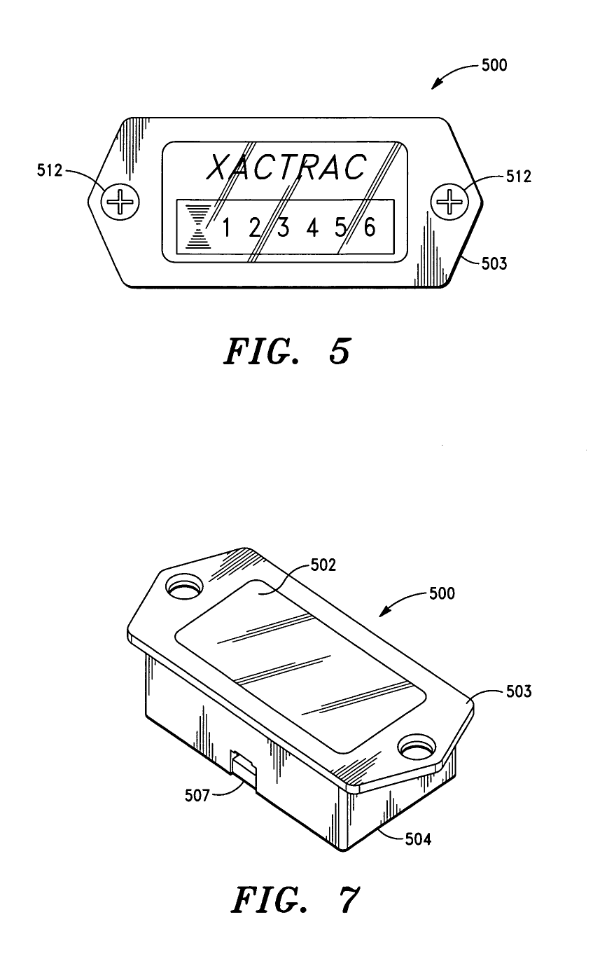

A particularly preferred external hour meter comprises the XacTrac® digital hour meter distributed by Guardian Global Technologies, Inc., which is illustrated in FIGS. 5-10. As discussed in detail below, a key feature of the XacTrac® digital hour meter is that it is designed and configured to facilitate three different vehicle mounting modes or applications.

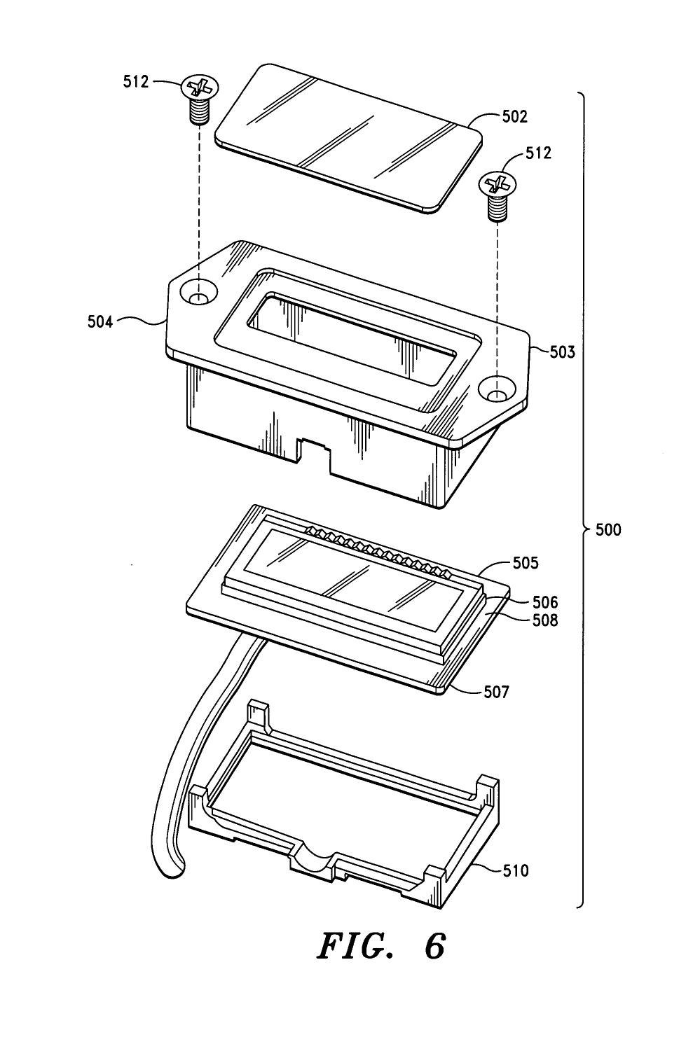

Referring first to FIGS. 5-7, there is shown the base XacTrac® digital hour meter 500. As illustrated in FIG. 6, the base meter 500 includes a lens 502, top case 504, bottom case 510 and a LCD-diffuser assembly 505, having an LCD 506, diffuser 508 and base (e.g. PCB) 507. The meter 500 also includes a pair of mounting screws 512.

As indicated, a key feature of the XacTrac® digital hour meter is that it is designed and configured to facilitate three different vehicle mounting modes; (i) mounted in a standard rectangular Hobbs opening, (ii) mounted in a standard round opening, and (iii) surface mounted.

As will readily be appreciated by one having ordinary skill in the art, the base meter 500 can readily be mounted in a standard rectangular Hobbs opening and secured therein via the mounting screws 512, without any additional modifications or components.

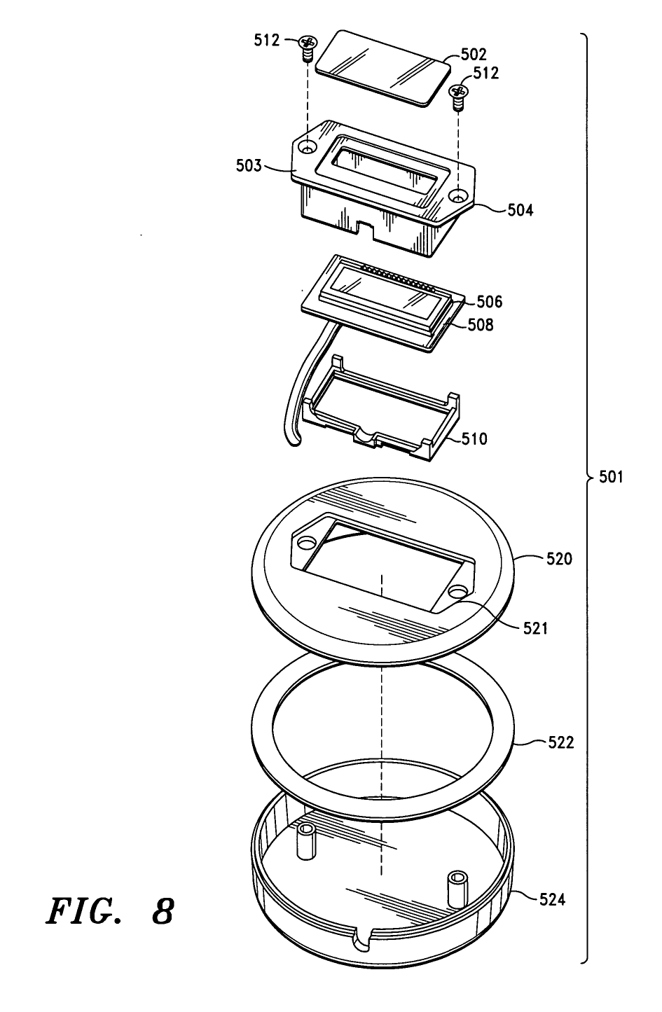

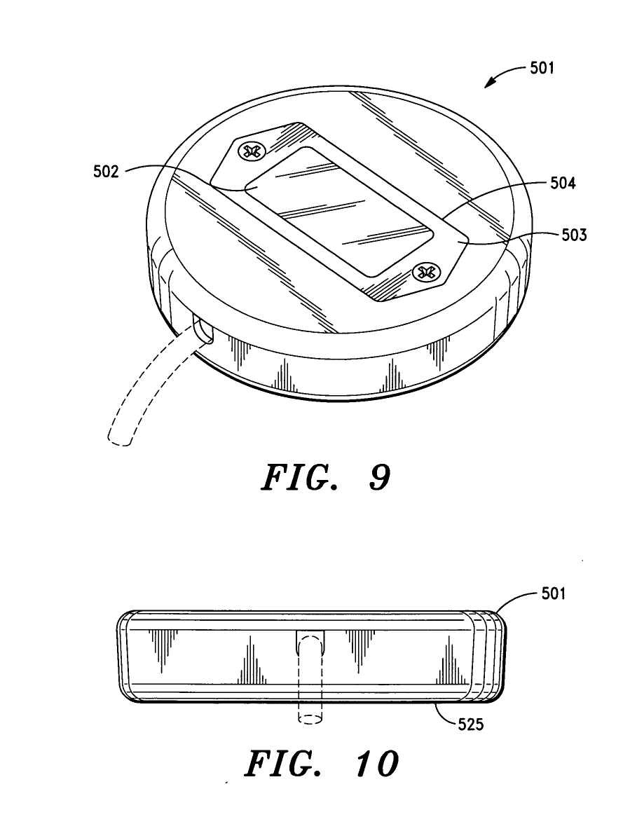

Referring now to FIGS. 8-10, to facilitate mounting in a standard round opening (e.g., 2 in. dia.) and to a surface, front and rear cases 520, 524, respectively, are provided. As illustrated in FIG. 9, the front case 520 includes a meter recess 521 that is adapted to receive the face 503 of the top case 504 therein. After the top case 504 is seated in the meter recess 521, the mounting screws 512 are employed to secure the top case 504 and, hence, base meter 500 to the front case 520.

To mount in a standard round opening, the provided two-sided adhesive foam ring 522 is initially secured to the front case 520. The assembled meter 501 is then positioned in the round opening and secured therein with the adhesive ring 522.

To mount to a desired vehicle surface, the rear case 524 is initially secured to the surface. According to the invention, the rear case 524 can be secured to the vehicle surface via an adhesive pad (not shown), which is disposed on the bottom surface 525 of the case 524, or via screws. After the rear case 524 is secured to the vehicle surface, the rear case 524 is secured to the front case 520 via the two-sided adhesive foam ring 522.

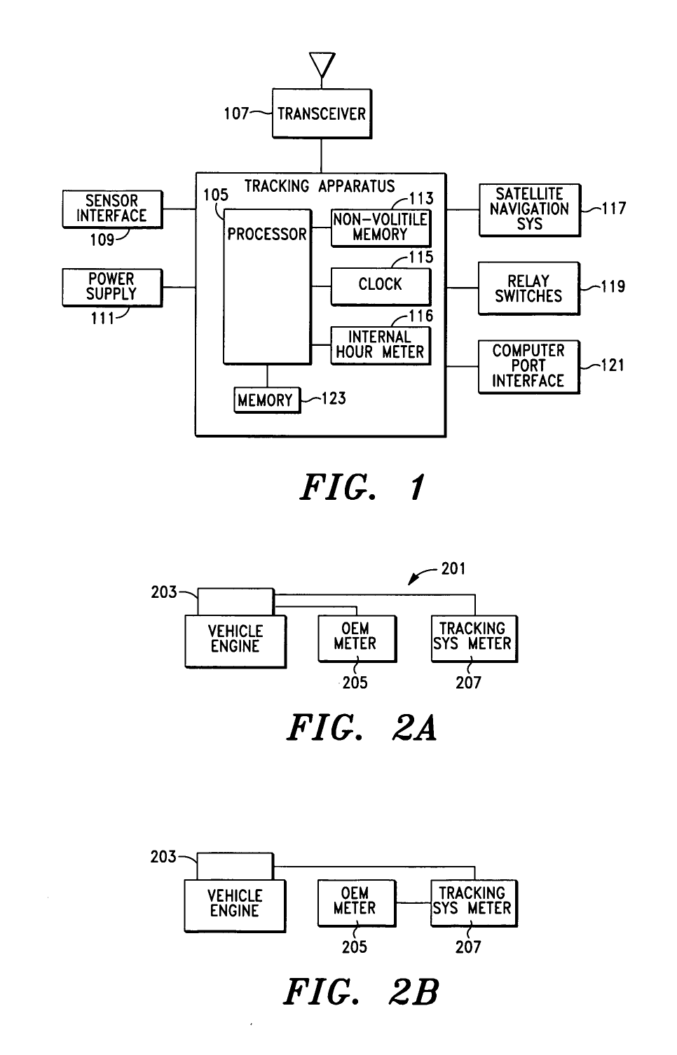

As indicated above, in a conventional telemetry tracking system, such as system 201 in FIG. 2A, wherein the OEM meter 205 and the telemetry tracking apparatus meter 207 are both connected to the equipment engine or motor 203, there is often a discrepancy between the engine (or motor) hours recorded by the OEM meter 205 and the telemetry apparatus meter 207.

The equipment tracking apparatus 103 of the invention eliminates the noted discrepancy by operatively directly communicating with the OEM meter 205 (or XacTrac® digital hour meter 500, described above), as shown in FIG. 2B.

In a preferred embodiment, the processor 105 is further adapted to reconcile the engine hours recorded by the OEM meter 205 (or XacTrac® digital hour meter 500) and the tracking apparatus meter 207. As discussed in detail above, the equipment tracking apparatus 103 and, hence, tracking apparatus meter 207 (or timer(s)) can also be updated, modified, etc. via transmitted communications.

In a preferred embodiment, the processor 105 is additionally adapted to transmitting the equipment history (or portion(s) thereof), for example, to a host computer for further processing. Accordingly, the history (or desired portion thereof) can be retrieved from the memory 123; formatted for transmission, and transmitted in accordance with the transceiver 107 and/or the computer port interface 121.

According to the invention, transmittal of the history can be initiated by a request for the history (received over the transceiver 107 and/or the computer port interface 121), or can be initiated automatically by the equipment tracking apparatus 103, e.g., periodically or in response to particular event conditions.

Accordingly, one or more embodiments can provide that the processor is further configured to facilitate receiving, from the transceiver, a request for vehicle history, and responsive to the request for vehicle history, transmitting at least a portion of the vehicle history over the transceiver. Further, one or more embodiments can include a computer port interface, such as port or interface 121, for transmitting communications when operably connected to a computer communication network; wherein the processor is further configured to facilitate transmitting, over the computer port interface, communications to transmit the vehicle history.

Furthermore, one or more embodiments provide that the processor is configured to facilitate first receiving, from the location interface, indications of a current location; determining, responsive to the location signal, a determined current location of the vehicle (and optionally, a velocity of the vehicle, and a heading of the vehicle); second receiving, from the sensor interface, a sensed status of the vehicle; first recording a pre-defined event condition, when the pre-defined event condition occurs responsive to the sensed status, in a vehicle history; and second recording the determined current location (and optionally the velocity and the heading) in the vehicle history. According to one or more embodiments, the second recording occurs at a pre-determined interval, for example a user-defined number of seconds, minutes, hours and/or days, and the pre-determined interval can be changed manually or semi-manually.

Moreover, according to one or more alternate embodiments, the processor is configured to indicate the occurrence of a pre-defined event condition response to a combination of the sensed status and a pre-determined sensor state.

In some embodiments, the processor 105 can provide relay switch processing, for example, when the equipment tracking apparatus 103 receives a communication in accordance with the transceiver 107 or the computer port interface 121 instructing that a relay switch is to be switched. By way of example, if a run-hour meter value exceeds a defined value, a warning light can be activated or an engine kill switch (or circuit) activated.

Accordingly, one or more embodiments provide that the processor is further configured to facilitate receiving, in accordance with the transceiver, a communication with an indication that the at least one relay switch is to be switched; and responsive to the indication, switching the at least one relay switch.

According to the invention, the equipment tracking apparatus 103 can be used in one or more of multiple modes, and optionally, can be selected depending on the user's preferences. Such modes can include, by way of example, real time monitoring, short term vehicle history recording, and/or long term vehicle history recording. Illustrative examples of these modes are provided below.

### Real Time Monitoring

By incorporating a wireless transceiver as part of a wireless network (Local or Wide Area Cellular), a remote host computer can interrogate the equipment tracking apparatus in real time, for example, to determine its location, and/or to read the state of the sensors or alarm conditions, and/or to switch the relays. For example, a construction site manager may need to determine the current location of equipment continuously to properly regulate construction activities.

### Short Term Vehicle History Recording

The equipment tracking apparatus 103 can be used with a low cost, short range radio transceiver, such as when periodic (such as daily or weekly) equipment checks are desired. The equipment tracking apparatus can include suitable memory, such as a non-volatile memory, to record various equipment parameters, including satellite navigation system (such GPS) positions at user specified intervals and records of predefined event conditions.

The short term vehicle history recording mode may be useful for an equipment owner that wants to automate vehicle maintenance checks. For example, after a work day, the equipment tracking apparatus can automatically link with an office PC to download the miles driven and/or engine hours and/or any engine alarms that may have occurred. The host computer can also be used for further processing, for example, to determine if any servicing is required, and to issue a work order to initiate the servicing.

### Long Term Vehicle History Recording

Since the equipment tracking apparatus 103 can have programmable record intervals, it is suitable for use in long term recording applications as well. The equipment tracking apparatus 103 can be used without a radio transceiver to reduce cost, for example, when only long term (such as at least quarterly or annually) equipment checks are required. The long term vehicle history recording mode may be useful for a leasing company that wants to know how the equipment was used and maintained while it was in the hands of the lessee over an extended period of time.

The equipment tracking apparatus 103 is also preferably removable from the equipment, whereby the equipment tracking apparatus 103 can be removed from the equipment upon return, and connected via a local data interface to the host computer for data downloading and subsequent processing and/or review.

Accordingly, one or more embodiments provide a non-volatile memory (see, e.g. memory 115) operably communicating with the processor 105, the vehicle history being stored in the non-volatile memory.

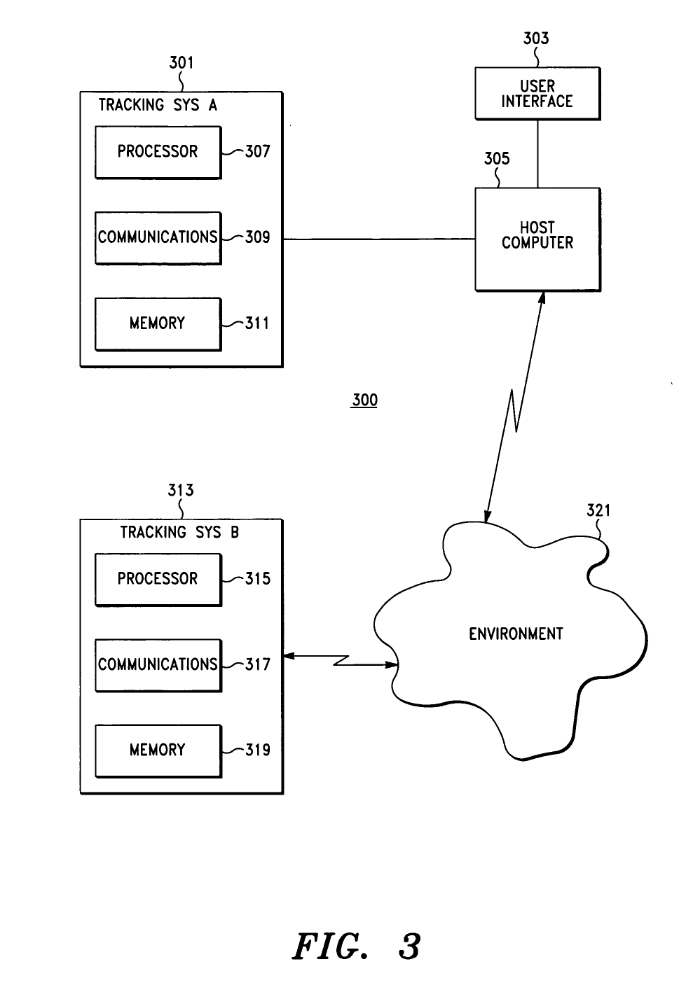

Referring now to FIG. 3, there is shown a diagram illustrating a simplified and representative environment 321 associated with an equipment tracking system 300 having equipment tracking apparatus 301, 313 and a host computer 305. As illustrated in FIG. 3, each equipment tracking apparatus 301, 313 can include a processor 307, 315, a communication interface 309, 317, and memory 311, 319. The host computer 305 optionally can include a user interface, such as display 303.

According to the invention, the first vehicle tracking apparatus 301 can establish a direct connection for communication with the host computer 305 in accordance with the communication interface 309, in this instance, a computer port interface. This can be convenient for establishing a local connection between the host computer 305 and the equipment tracking apparatus 301.

The second vehicle tracking apparatus 313 is illustrated to provide an example of remote communication with the host computer 305 in accordance with the communication interface 317, which in this instance, comprises a transceiver.

Accordingly, one or more embodiments provides for a transceiver, for at least one of receiving and transmitting communications when operably connected to a communication network. Further, one or more embodiments provides for a transceiver, for at least one of receiving and transmitting communications when operably connected to a wireless communication network.

The use of a transceiver on the equipment tracking apparatus 313 can be convenient for establishing the remote connection between the host computer 305 and the equipment tracking apparatus 313. Although the illustrated equipment tracking apparatus 301, 313 utilize separate local and remote communication capability, one or more embodiments can provide that the equipment tracking apparatus includes both local and remote communication capability.

The user interface 303 provided on the host computer 305 can be utilized for example, to display reports of equipment histories, to provide one or more alarms relating to equipment status, and/or to interact with a user to initiate communications to the equipment tracking apparatus 301, 313.

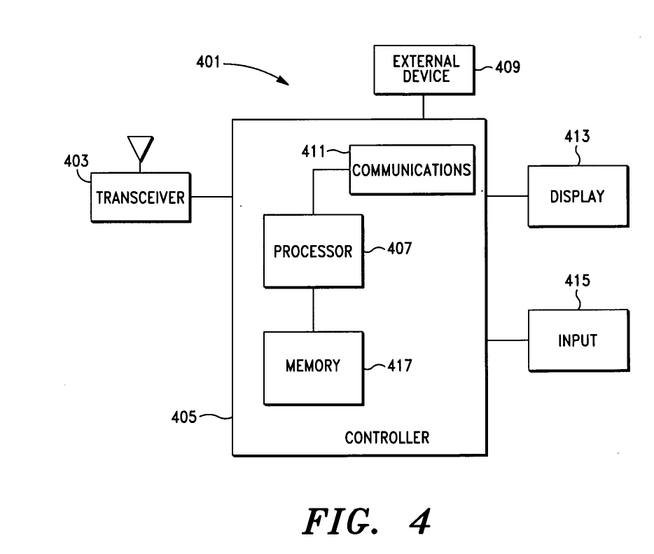

Referring now to FIG. 4, there is shown a block diagram illustrating portions of an exemplary host computer 401 in accordance with various embodiments of the invention. According to the invention, the host computer 401 can include, inter-coupled (as generally depicted), a controller 405, transceiver 403, display 413, and/or a user input device, such as the illustrated keypad 415. The controller 405 further includes a communication interface 411 for communication with an optional external device 409 (such as an equipment tracking apparatus), processor 407, and memory 417.

According to the invention, the processor 407 can comprise one or more microprocessors and/or one or more digital signal processors. Further, the memory 417 can comprise one or more of a read-only memory (ROM), a random-access memory (RAM), a programmable ROM (PROM), and/or an electrically erasable read-only memory (EEPROM).

The memory 417 can further include multiple memory locations for storing, for example, an operating system, data and variables for managing general execution by the processor 407; computer programs for causing the processor 407 to operate in connection with various functions, such as equipment location/status processing function, clear equipment history function, equipment sensor/alarm and relay processing, and/or other processing; a database for the equipment history; and/or a database for other miscellaneous information used by the processor 407.

According to one or more embodiments, the processor 407 can be programmed for the equipment location/status processing. For example, the processor 407 can receive communications over the transceiver 403 and/or in accordance with the communication interface 411, where the communications include indications of equipment location and/or status. The equipment location and/or status can be stored, for example, in the equipment history database and/or utilized for further processing and/or report preparation.

One or more embodiments provide that the processor 407 includes a clear equipment history function. The host computer 401 can thus transmit a communication to the equipment tracking apparatus instructing it to clear its memory. The communication can instruct the equipment tracking apparatus to clear all or part of its memory. This can be useful, for example, to clear the memory after receiving the equipment history and/or before reinstalling the equipment tracking apparatus in or on another piece of equipment or motorized vehicle.

According to the invention, the processor 407 can also provide equipment sensor/alarm and relay processing, where the host computer 401 can request and/or receive indications from equipment sensors and/or alarms from an equipment tracking apparatus, and/or can transmit indications of relay switches for an equipment tracking apparatus. The relay switch can be instructed to be switched in response to the equipment's location and/or sensor state. A relay can also be associated with an alarm, so that the alarm can be notified.

Accordingly, it may be desirable for the equipment sensor/alarm and relay processing to determine if the alarm should be notified. For example, an alarm can be notified and activated where the equipment history indicates maintenance is due, or velocity/location is outside of a permitted range.

Accordingly, one or more embodiments provide that the relay can be associated with an alarm, further comprising determining at least one piece of equipment to which an alarm is to be notified responsive to the equipment history.

Further, one or more embodiments provide for first communicating with a plurality of equipment tracking apparatus, a respective equipment tracking apparatus being associated with one piece of equipment, and receiving an equipment history of equipment location and equipment status associated with respective equipment from the respective equipment tracking apparatus; after receiving an equipment history from at least one of the equipment tracking apparatus, the at least one equipment tracking apparatus having a memory for storing the history, instructing the at least one equipment tracking apparatus to clear the history from the memory; and second communicating wirelessly with equipment tracking apparatus to obtain respective current locations of the respective pieces of equipment; to obtain respective current states of a sensor or an alarm on the respective equipment; and to instruct a relay on the respective equipment to be switched responsive to at least one of the current location of the respective equipment and the current state.

According to the invention, a user may invoke functions, such as programming the processor 407, through the user input device 415. The user input device 415 can comprise one or more of various known input devices, such as a keypad, a computer mouse, a touchpad, a touch screen, a trackball, and/or a keyboard.

The display 413 can present information to the user by way of a conventional display, liquid crystal display (LCD) and/or other visual display.

As will readily be appreciated by one having ordinary skill in the art, the equipment tracking apparatus and associated system can also be incorporated in Applicant's remote vehicle theft detection system, which is described in detail in Co-Pending application Ser. No. 10/850,624.

As stated, this disclosure is provided to explain in an enabling fashion the best modes of performing one or more embodiments of the present invention. The disclosure is further offered to enhance an understanding and appreciation for the inventive principles and advantages thereof, rather than to limit in any manner the invention. The invention is thus defined solely by the appended claims including any amendments made during the pendency of this application and all equivalents of those claims as issued.

Without departing from the spirit and scope of this invention, one of ordinary skill can make various changes and modifications to the invention to adapt it to various usages and conditions. As such, these changes and modifications are properly, equitably, and intended to be, within the full scope and range of equivalence of the appended claims including any amendments made during the pendency of this application and all equivalents of those claims as issued.

What is claimed is:

1. A tracking system for monitoring motorized equipment, comprising:
a tracking device that is connectable to at least one equipment interface that is in communication with an equipment system and is adapted to sense a characteristic state associated with said equipment system,
said tracking device including a power supply, memory means for storing at least a first equipment characteristic state, processing means having at least a first program associated therewith for processing said first equipment characteristic state and generating at least a first equipment system history as a function of said first equipment characteristic state, and
telematic transmission means for receiving user command signals, and transmitting at least a first system signal representing equipment system information associated with said first equipment system history.

2. The tracking system of claim 1, wherein the equipment includes an engine hour meter, and wherein said tracking system includes an internal engine hour meter.

3. The tracking system of claim 2, wherein said memory means is further adapted to store first engine hour data transmitted by said equipment engine hour meter and second engine hour data transmitted by said tracking device engine hour meter.

4. The tracking system of claim 3, wherein said processing means further includes at least a second program associated therewith that is adapted to reconcile said first and second engine hour data.

5. The tracking system of claim 4, wherein said first equipment system history includes said first and second engine hour data and said reconciled engine hour data.

6. The tracking system of claim 5, wherein said processing means is further adapted to record in said memory means a pre-defined event condition in said first equipment system history in response to said first sensed characteristic state.

7. The tracking system of claim 6, wherein said processing means is further adapted to record in said memory means a pre-defined event condition in said first equipment system history in response to said reconciled engine hour data.

8. The tracking system of claim 5, wherein said processing means is further adapted to receive a first user command signal representing a request for first equipment system information associated with said first equipment system history from said transmission means, and responsive to said first user command signal, transmitting said first equipment system information to said telematic transmission means.

9. The tracking system of claim 8, wherein said first equipment system information comprises at least a first portion of said first equipment system history.

10. The tracking system of claim 8, wherein said first equipment system information comprises said first equipment characteristic state.

11. The tracking system of claim 8, wherein said first equipment system information comprises said reconciled engine hour data.

12. The tracking system of claim 8, wherein said first equipment system information is transmitted to an external receiving device by said telematic transmission means.

13. The tracking system of claim 12, wherein said telematic transmission means comprises wireless transmission means.

14. The tracking system of claim 12, wherein said telematic transmission means comprises wired transmission means.

15. The tracking system of claim 14, wherein said tracking device includes a computer port interface connectable to an external processor to facilitate communications between said external receiving device and said tracking device.

16. The tracking system of claim 15, wherein said external receiving device comprises a processor.

17. The tracking system of claim 1, wherein said equipment interface comprises a location interface, and wherein said processing means is further adapted to receive a first location signal representing a first current location of the equipment from said location interface, and responsive to said first location signal determining a first heading of the equipment.

18. The tracking system of claim 17, wherein said processing means is further adapted to determine a first velocity of the equipment in response to said first location signal.

19. The tracking system of claim 17, wherein said system includes a satellite navigation system, and wherein said first location signal is derived from said satellite navigation system.
